(19) United States
(12) Patent Application Publication
(10) Pub. No.: US 2025/0192709 A1
(43) Pub. Date: Jun. 12, 2025

(54) MOTOR DRIVING DEVICE AND COOLING CYCLE DEVICE

(71) Applicant: Carrier Japan Corporation, Tokyo (JP)

(72) Inventors: Yoshitaka Uchiyama, Fuji-shi (JP); Masaki Kanamori, Fuji-shi (JP)

(21) Appl. No.: 19/059,486

(22) Filed: Feb. 21, 2025

Related U.S. Application Data
(63) Continuation of application No. PCT/JP2022/031667, filed on Aug. 23, 2022.

(51) Int. Cl. H02P 25/22; F25B 31/02

(52) U.S. Cl. CPC H02P 25/22; F25B 31/02; H02P 2209/03

(57) ABSTRACT

This motor driving apparatus comprises a first inverter, a second inverter, a plurality of opening and closing connections, a plurality of semiconductor switch elements, and a controller. The controller, at the opening or closing of the opening and closing connections, executes a pseudo neutral point operation and turns on the semiconductor switch elements in advance. First wirings each have a first inductance, second wirings each have a second inductance, and third wirings each have a third inductance. The third inductance value is smaller than the total of the first inductance value and the second inductance value.

### CROSS-REFERENCE TO RELATED APPLICATIONS

This application is a Continuation Application of PCT Application No. PCT/JP2022/031667, filed Aug. 23, 2022, the entire contents of which are incorporated herein by reference.

### BACKGROUND OF THE INVENTION

### 1. Field of the Invention

The present invention relates generally to a motor drive apparatus for a motor including a plurality of phase wires that are not connected to each other, and a refrigeration cycle apparatus equipped with the motor drive apparatus.

### 2. Description of the Related Art

As drive motors for a compressor installed in a refrigeration cycle apparatus such as an air conditioner, a permanent magnet synchronous motor having a plurality of phase wires, and an open-winding motor (Open-Winding Motor) having a plurality of, for example, three phase wires that are disconnected to each other are known.

A motor drive apparatus that drives an open-winding motor (abbreviated as a motor) comprise a first inverter that controls energization to one end of each phase wire of the motor, a second inverter that controls energization to the other end of each phase wire of the motor, and one or more switches for interconnecting the other ends of the respective phase wires, and selectively sets a star connection mode of switching the first inverter independently to drive the motor by making interconnection or so-called star connection (also referred to as a star-shaped connection) of the other ends of the respective phase wires by closing the switches, and an open-winding mode of switching the first and second inverters in association with each other to drive the motor in a disconnected state of separating the other ends of the respective phase wires by opening the switches.

A voltage applied to each phase wire can be increased to overcome the back electromotive force generated in a permanent magnet synchronous motor and drive the motor at high rotation speeds by setting the open-winding mode, and the motor can be driven with high efficiency by setting the star connection mode in a low rotation range. In other words, the motor can be driven as efficiently as possible over a wide operation range from high rotation speeds to low rotation speeds. Therefore, it is possible to both expand the operation range of the motor and improve the efficiency of the motor drive apparatus.

In motor drive in the star connection mode, the current (motor current) flowing between the first inverter and each phase wire passes through the switch. By using a mechanical switching contact with a small resistance value, such as a relay contact, as the switch, power loss in the switch can be reduced and the motor efficiency can be improved.

During the motor drive, however, a potential difference occurs between both ends of the switching contacts, i.e., between the other ends of the respective phase wires. When the switching contact opens and closes in a state in which such a potential difference occurs, a surge voltage or an arc is generated between both ends of the switching contact, which adversely affects the life of the switching contact. Furthermore, the switching elements of each inverter may be destroyed by these surge voltages and arcs.

For this reason, as a countermeasure, a pseudo-neutral point operation that does not cause a potential difference between both ends of the switching contact is executed by switching the second inverter, and, during its operation, control is performed to open and close the relay contact.

### BRIEF SUMMARY OF THE INVENTION

As a result of various tests, however, it has been found that even during the pseudo-neutral operation, a potential difference may occur between the opening and closing contacts, depending on the relationship between the switching timing of the second inverter and the operation timing of the relay contacts.

Therefore, embodiments described herein aim to provide a motor drive apparatus and a refrigeration cycle apparatus with excellent safety and reliability capable of suppressing the potential difference between both ends of the opening and closing contact to be as small as possible.

A motor drive apparatus according to an embodiment is a motor drive apparatus of a motor including a plurality of phase wires disconnected to each other, and the motor drive apparatus comprises: a first inverter including a plurality of series circuits of upper switch elements and lower switch elements, both ends of the series circuits being connected to a DC power supply, an interconnection point of the upper switch element and the lower switch element of each of the series circuits being connected to one end of each of the phase wires; a second inverter including a plurality of series circuits of upper switch elements and lower switch elements, both ends of the series circuits being connected to the DC power supply, an interconnection point of the upper switch element and the lower switch element of each of the series circuits being connected to the other end of each of the phase wires by each of first wires; a plurality of switching contacts connected between the other ends of each of the phase wires by each of second wires; a plurality of semiconductor switch elements connected in parallel to each of the switching contacts by each of third wires; and a controller controlling drive of the first inverter, drive of the second inverter, and opening and closing of each of the switching contacts. During opening and closing each of the switching contacts, the controller executes a pseudo-neutral point operation of alternately turning on and off all the upper switch elements and all the lower switch elements in the second inverter and turns on each of the semiconductor switch elements, in advance. Each of the first wires has a first inductance, each of the second wires has a second inductance, and each of the third wires has a third inductance. A value of the third inductance is smaller than a total value of the value of the first inductance and the value of the second inductance.

The refrigeration cycle apparatus of the embodiment comprises a compressor driven by the motor drive apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 a block diagram showing a configuration of a first embodiment.

FIG. 2 is a flowchart showing the control of the first embodiment.

FIG. 3 is a time chart showing the pseudo-neutral point operation and the closing operation of each switching contact, which are executed when switching from an open-winding mode to the star connection mode in the first embodiment.

FIG. 4 is a time chart showing the pseudo-neutral point operation and the opening operation of each switching contact, which are executed when switching from the star connection mode to the open-winding mode in the first embodiment.

FIG. 5 is a time chart showing on/off of each switch element in the pseudo-neutral point operation of FIG. 3 and FIG. 4 in a temporally enlarged manner.

FIG. 6 is a diagram showing a current flow during a dead time in the first embodiment.

FIG. 7 is a chart showing changes in voltage and potential difference at various parts when the current shown in FIG. 6 flows.

FIG. 8 is a chart showing other changes in voltage and potential difference at various parts when the current shown in FIG. 6 flows.

FIG. 9 a block diagram showing a configuration of a second embodiment.

FIG. 10 a block diagram showing a configuration of a third embodiment.

FIG. 11 a block diagram showing a configuration of a fourth embodiment.

### DETAILED DESCRIPTION OF THE INVENTION

### (1) First Embodiment

The first embodiment will be described hereinafter with reference to the accompanying drawings.

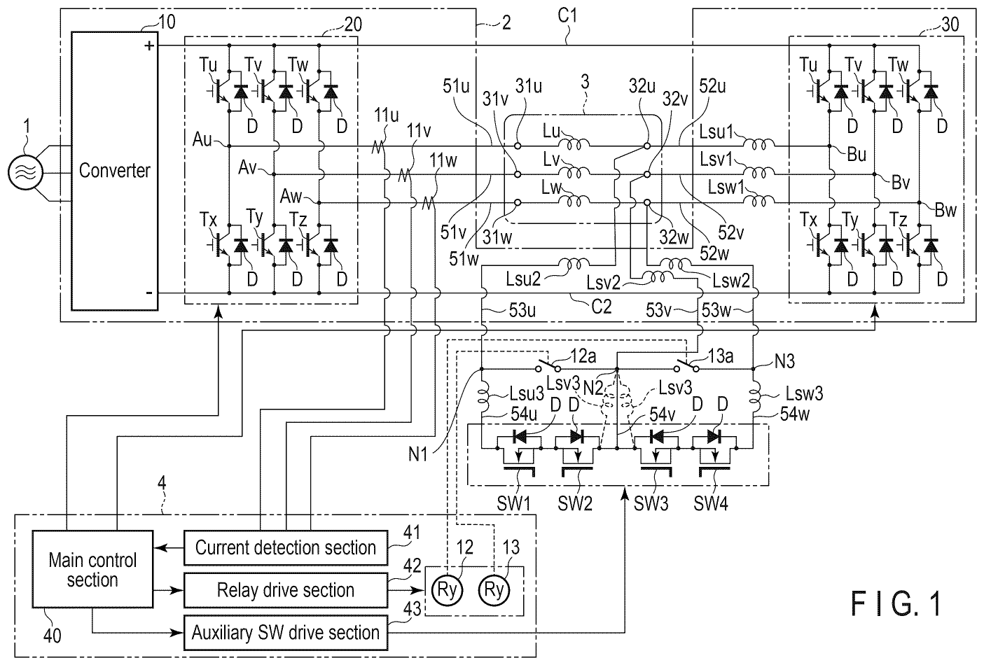

As shown in FIG. 1, a motor drive circuit 2 is connected to a three-phase AC power source 1, and a motor 3 and a controller 4 are connected to an output end of the motor drive circuit 2. In this embodiment, the motor 3 is a compressor drive motor that drives a compressor of an air conditioner, which is a refrigeration cycle apparatus.

The motor 3 is a three-phase permanent magnet synchronous motor for driving a compressor, including three phase wires Lu, Lv, and Lw that are disconnected to each other and, more specifically, a so-called open-winding motor including three terminals 31u, 31v, and 31w that are ends of the respective phase wires Lu, Lv, and Lw and three terminals 32u, 32v, and 32w that are the other ends of the respective phase wires Lu, Lv, and Lw.

The motor drive circuit 2 includes a DC power source, for example, a converter 10, connected to the three-phase AC power source 1, a positive power line C1 and a negative power line C2 connected to the output end of the converter 10, and an inverter (first inverter) 20 and an inverter (second inverter) 30 connected between the positive power line C1 and the negative power line C2.

The converter 10 is, for example, a full-wave rectifier or a PWM converter, and converts the AC voltage of the three-phase AC power source 1 into a DC voltage. The inverter 20 controls energization to the terminals 31u, 31v, and 31w, which are the ends of the respective phase wires Lu, Lv, and Lw of the open-winding motor 3. The inverter 30 controls energization to the terminals 32u, 32v, and 32w, which are the other ends of the respective phase wires Lu, Lv, and Lw of the open-winding motor 3. The converter 10 adopts a configuration of a DC link common system, which is a common DC power source for the inverters 20 and 30.

The inverter 20 is a so-called three-phase inverter including a U-phase series circuit formed by connecting an upper switch element Tu and a lower switch element Tx in series, a V-phase series circuit formed by connecting an upper switch element Tv and a lower switch element Ty in series, and a W-phase series circuit formed by connecting an upper switch element Tw and a lower switch element Tz in series. One end of each of the U-phase series circuit, the V-phase series circuit, and the W-phase series circuit is connected to the positive power line C1, and the other end of each of the U-phase series circuit, the V-phase series circuit, and the W-phase series circuit is connected to the negative power line C2.

An interconnection point Au of the upper switch element Tu and the lower switch element Tx is connected to a terminal 31u, which is one end of the phase wire Lu, by a wire 51u such as a lead wire or a conductive pattern. An interconnection point Av of the upper switch element Tv and the lower switch element Ty is connected to a terminal 31v, which is one end of the phase wire Lv, by a wire 51v such as a lead wire or a conductive pattern. An interconnection point Az of the upper switch element Tw and the lower switch element Tz is connected to a terminal 31w, which is one end of the phase wire Lz, by a wire 51w such as a lead wire or a conductive pattern.

The inverter 30 is a so-called three-phase inverter having the same circuit configuration as the inverter 20, and including a U-phase series circuit formed by connecting an upper switch element Tu and a lower switch element Tx in series, a V-phase series circuit formed by connecting an upper switch element Tv and a lower switch element Ty in series, and a W-phase series circuit formed by connecting an upper switch element Tw and a lower switch element Tz in series. One end of each of the U-phase series circuit, the V-phase series circuit, and the W-phase series circuit is connected to the positive power line C1, and the other end of each of the U-phase series circuit, the V-phase series circuit, and the W-phase series circuit is connected to the negative power line C2.

An interconnection point Bu of the upper switch element Tu and the lower switch element Tx is connected to a terminal 32u, which is the other end of the phase wire Lu, by a wire (first wire) 52u such as a lead wire or a conductive pattern. An interconnection point By of the upper switch element Tv and the lower switch element Ty is connected to a terminal 32v, which is the other end of the phase wire Lv, by a wire (first wire) 52v such as a lead wire or a conductive pattern. An interconnection point Bw of the upper switch element Tw and the lower switch element Tz is connected to a terminal 32w, which is the other end of the phase wire Lz, by a wire (first wire) 52w such as a lead wire or a conductive pattern.

All the switch elements Tu to Tz of the inverters 20 and 30 are IGBT in which freewheeling diodes (also referred to as freewheeling diodes) D are connected in antiparallel to main bodies of the switch elements. In addition to IGBT, MOS-FET or the like may be used as each of the switch elements Tu to Tz.

Actually, the inverter 20 is a module in which a main circuit formed by bridge-connecting the U-phase series circuit, the V-phase series circuit, and the W-phase series circuit, and peripheral circuits such as the drive circuit for driving each switch element of this main circuit are housed in a single package or a so-called Intelligent Power Module (IPM). The inverter 30 is also an IPM. In addition to the IPM, the inverters 20 and 30 in which all the switch elements Tu to Tz and the drive circuits are configured as discrete components may be used. The inverters are not limited to the three-phase inverters, but the two three-phase inverters 20 and 30 may be configured with three single-phase inverters since switching of six phases needs only to be formed.

A switch including a mechanical switching contact, for example, a normally open first switching contact (referred to as a relay contact) 12a of a relay 12 is connected between the other end (terminal 32u) of the phase wire Lu and the other end (terminal 32v) of the phase wire Lv in a motor 1M, by wires (second wires) 53u and 53v such as lead wires and conductive patterns. A switch including a mechanical switching contact, for example, a normally open second switching contact (referred to as a relay contact) 13a of a relay 13 is connected between the other end (terminal 32v) of the phase wire Lv and the other end (terminal 32w) of the phase wire Lw in the motor 1M, by wires (second wires) 53v and 53w such as lead wires and conductive patterns. The relays 12 and 13 are controlled to be turned on (energized) by supplying an excitation current and turned off (deenergized) by cutting off the excitation current, in synchronization with each other, by the controller 4. For this reason, one relay including two relay contacts may be used instead of two relays 12 and 13.

By turning on (energizing) the relays 12 and 13, the relay contacts 12a and 13a are closed, the other end of the phase wire Lu and the other end of the phase wire Lv are interconnected via the relay contact 12a, and the other end of the phase wire Lv and the other end of the phase wire Lw are interconnected via the relay contact 13a. In other words, the phase wires Lu, Lv, and Lw are in a star connection state (also referred to as a star connection state). By turning off (deenergizing) the relays 12 and 13, the relay contacts 12a and 13a are opened, and the phase wires Lu, Lv, and Lw become in a disconnected state of being separated from each other, i.e., an open-winding state of being electrically separated.

Furthermore, a series circuit of auxiliary switches SW1 and SW2 is connected in parallel to the relay contact 12a through wires (third wires) 54u and 54v such as lead wires and conductive patterns. A series circuit of auxiliary switches SW3 and SW4 is connected in parallel to the relay contact 13a through wires (third wires) 54v and 54w such as lead wires and conductive patterns.

More specifically, one end of the series circuit of the auxiliary switches SW1 and SW2 is connected to a connection point N1 between the wire 53u and one end of the relay contact 12a via the wire 54u. The other end of the series circuit of the auxiliary switches SW1 and SW2 is connected and one end of the series circuit of the auxiliary switches SW3 and SW4 is connected via the same wire 54v, to a connection point N2 between the wire 53v and the other end of the relay contact 12a (and one end of the relay contact 12b). The other end of the series circuit of the auxiliary switches SW3 and SW4 is connected to a connection point N3 between the wire 53w and the other end of the relay contact 12b via the wire 54w. The connection points N1, N2, and N3 are branch points from the wires 53u, 53v, and 53w to the wires 54u, 54v, and 54w. The connection points N1, N2, and N3 are hereinafter referred to as branch points N1, N2, and N3.

In other words, the wires 53u, 53v, and 53w start at the terminals 32u, 32v, and 32w, which are the other ends of the motor wires Lu, Lv, and Lw, and end at the branch points N1, N2, and N3. The first and second wires 54u and 54v start at the branch points N1 and N2 and end at both ends of the series circuit of the auxiliary switches Sw1 and Sw2. The second and third wires 54v and 54w start at the branch points N2 and N3 and end at both ends of the series circuit of the auxiliary switches Sw3 and Sw4.

The auxiliary switches SW1 to SW4 are semiconductor switch elements in which a freewheeling diode D is connected to the main body of each element in an antiparallel direction. The series circuit of the auxiliary switches SW1 and SW2 is connected such that the auxiliary switches SW1 and SW2 are provided in opposite directions. In other words, outputs (current outflow sides) of both the auxiliary switches SW1 and SW2 are connected to each other. Similarly, the series circuit of the auxiliary switches SW3 and SW4 is also connected such that the auxiliary switches SW3 and SW4 are provided in opposite directions. For this reason, in the series circuit of the auxiliary switches SW1 and SW2, a current flows in both directions via the freewheeling diode D of one of the auxiliary switches when the auxiliary switches SW1 and SW2 are turned on, and no current flows in either direction when the auxiliary switches SW1 and SW2 are turned off. Similarly, in the series circuit of the auxiliary switches SW3 and SW4, a current flows in both directions via the freewheeling diode D of one of the auxiliary switches when the auxiliary switches SW3 and SW4 are turned on, and no current flows in either direction when the auxiliary switches SW3 and SW4 are turned off.

The wire 52u between the interconnection point Bu of the inverter 30 and the other end (terminal 32u) of the phase wire Lu has a first inductance (parasitic inductance) Lsu1. The wire 53u between the other end (terminal 32u) of the phase wire Lu and the branch point N1 has a second inductance (parasitic inductance) Lsu2. The wire 52v between the interconnection point By of the inverter 30 and the other end (terminal 32v) of the phase wire Lv has a first inductance (parasitic inductance) Lsv1. The wire 53v between the other end (terminal 32v) of the phase wire Lv and the branch point N2 has a second inductance Lsv2. The wire 52w between the interconnection point Bw of the inverter 30 and the other end (terminal 32w) of the phase wire Lw has a first inductance (parasitic inductance) Lsw1. The wire 52w between the other end (terminal 32w) of the phase wire Lw and the branch point N3 has a second inductance Lsw2. The first inductances Lsu1, Lsv1, and Lsw1 have substantially the same value, but may be slightly different in magnitude depending on routing conditions of each of the wires 52u, 52v, and 52w. Similarly, the second inductances Lsu2, Lsv2, and Lsw2 have substantially the same value, but may be slightly different in magnitude depending on routing conditions of each of the wires 53u, 53v, and 53w.

The wire 54u between the branch point N1 and one end of the series circuit of the auxiliary switches SW1 and SW2 has a third inductance (parasitic inductance) Lsu3. The wire 54v has a third inductance Lsv3 between the branch point N2 and the other end of the auxiliary switches SW1 and SW2, and also has the same third inductance Lsv3 between the branch point N2 and one end of the auxiliary switches SW3 and SW4. Incidentally, since the wire at the connection part between the collector of the auxiliary switch SW2 and the collector of the auxiliary switch SW3 may be extremely short, the inductance of the wire from the branch point N2 to the connection point between the auxiliary switch SW2 and the auxiliary switch SW3 is substantially dominant as the third inductance Lsv3 of the wire 54v. The wire 54w between the branch point N3 and the other end of the series circuit of the auxiliary switches SW3 and SW4 has a third inductance Lsw3.

In summary, the relay contact 12a is connected between the branch points N1 and N2, and a series circuit of the auxiliary switches SW1 and SW2 is connected between the branch points N1 and N2. The relay contact 13a is connected between the branch points N2 and N3, and the series circuit of the auxiliary switches SW3 and SW4 is connected between the branch points N2 and N3.

Current sensors 11u, 11v, and 11w are provided at the wires 51, 51v, and 51z between the interconnection points Au, Av, and Az of the inverter 20 and ends (terminals 31u, 31v, and 31z) of the respective phase wires Lu, Lv, and Lw, and output signals of these current sensors are sent to the controller 4. The current sensors 11u, 11v, and 11w detect currents (referred to as motor currents) Iu, Iv, and Iw flowing through the phase wires Lu, Lv, and Lw.

The controller 4 includes a main control section 40, a current detection section 41, a relay drive section 42, and an auxiliary SW drive section 43, and controls the opening/closing of the relay contacts 12a and 13a and the driving (switching) of the inverters 20 and 30 such that rotation speed N of the motor 3 becomes a target rotational speed Nt commanded by a higher-level external apparatus (for example, a control apparatus of an air conditioner) and that a highly efficient operation is achieved.

The current detection section 41 detects instantaneous values of the motor currents Iu, Iv, and Iw that are detected by the current sensors 11u, l1v, and 11w, respectively. The relay drive section 42 drives the relays 12 and 13 in response to commands from the main control section 40. The auxiliary SW drive section 43 drives the auxiliary switches SW1 to SW4 in accordance with commands from the main control section 40.

The main control section 40 is composed of a microcomputer and its peripheral circuits, and selectively sets a star connection mode of interconnecting the other ends of the phase wires Lu, Lv, and Lw by closing the relay contacts 12a and 13a to drive the inverter 20 independently, and an open-winding mode of making the other ends of the phase wires Lu, Lv, and Lw disconnected from each other by opening the relay contacts 12a and 13a to drive the inverters 20 and 30 in association with each other, in accordance with the values of the motor currents Iu, Iv, and Iw corresponding to the magnitude of the load, and the like. For example, the star connection mode is set at a low load time when the motor rotation speed N is low and the motor currents Iu, Iv, and Iw are less than a predetermined value, and the open-winding mode is set at a high load time when the motor rotation speed N increases and the motor currents Iu, Iv, and Iw become equal to and higher than a predetermined value. The high efficiency can be thereby obtained over the entire operating range of the motor. Incidentally, the selection of the star connection mode and the open-winding mode can be changed by making determination using various parameters related to the motor, such as a combination of the motor rotation speed and field weakening amount, in addition to the above elements. Incidentally, under abnormal conditions that the motor currents Iu, Iv, and Iw become overcurrent, one of the star connection mode and the open-winding mode may be preferentially changed.

When changing from the open-winding mode to the star connection mode and changing from the star connection mode to the open-winding mode, the main control section 40 executes the pseudo-neutral point operation of alternately turning on and off all the upper switch elements Tu, Tv, and Tw and all the lower switch elements Tx, Ty, and Tz in the inverter 30 with an on/off duty of 50% such that the potential difference between both ends of the relay contact 12a and the potential difference between both ends of the relay contact 13a become zero.

In particular, during execution of the pseudo-neutral point operation at the time of changing from the open-winding mode to the star connection mode, the main control section 40 turns on the relays 12 and 13 in a state of turning on the auxiliary switches SW1 to SW4 in advance, and turns off the auxiliary switches SW1 to SW4 after a certain time t1, which is longer than the time required for the relay contacts 12a and 13a to be closed, has actually elapsed. Similarly, during execution of the pseudo-neutral point operation at the time of changing from the star connection mode to the open-winding mode, the main control section 40 turns off the relays 12 and 13 in a state of turning on the auxiliary switches SW1 to SW4 in advance, and turns off the auxiliary switches SW1 to SW4 after a certain time t2, which is longer than the time required for the relay contacts 12a and 13a to be opened, has actually elapsed.

Incidentally, during on/off drive of each upper switch element and each lower switch element of the inverters 20 and 30 during the pseudo-neutral point operation, the main control section 40 executes a complementary operation in which the lower switch element is turned off when the upper switch element is turned on in each series circuit while the upper switch element is turned off and when the lower switch element is turned on in each series circuit. In this complementary operation, the main control section 40 ensures a dead time td in which both the upper switch element and the lower switch element become in an off state in the on/off drive such that the upper switch element and the lower switch element of each series circuit are not simultaneously turned on and a short circuit is not formed. Incidentally, the dead time td is always provided not only during the pseudo-neutral point operation but also during PWM control during the normal operation in order to prevent a short circuit between the upper and lower switch elements.

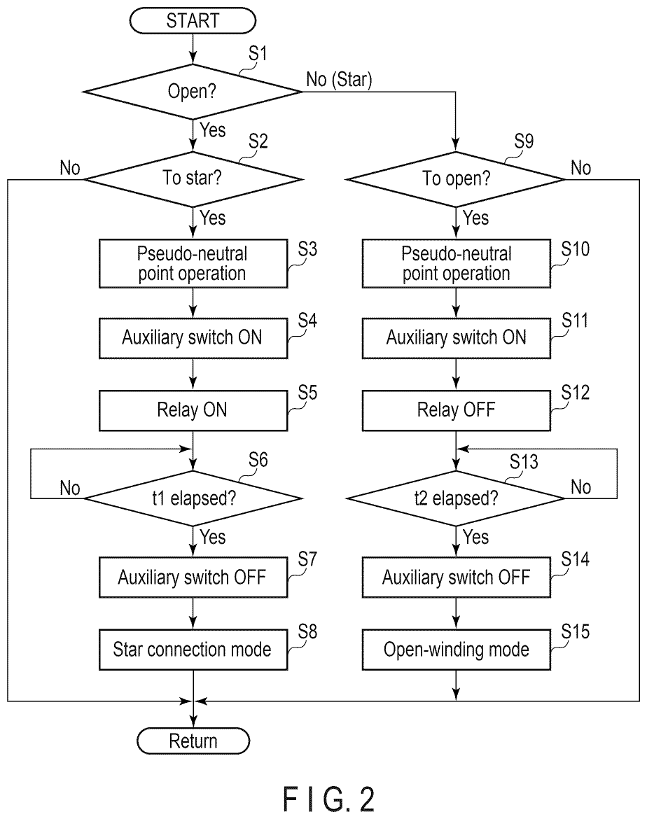

Next, the main controls executed by the main control section 40 of the controller 4 will be described with reference to the flowchart of FIG. 2. Steps S1, S2 . . . in the flowchart are simply referred to as S1, S2 . . . .

When the motor is driven in the open-winding mode (YES in S1), the main control section 40 monitors whether or not it is necessary to change the mode to the star connection mode in response to a decrease in load (S2). If changing to the star connection mode is unnecessary (NO in S2), the main control section 40 repeats the above determination in S1.

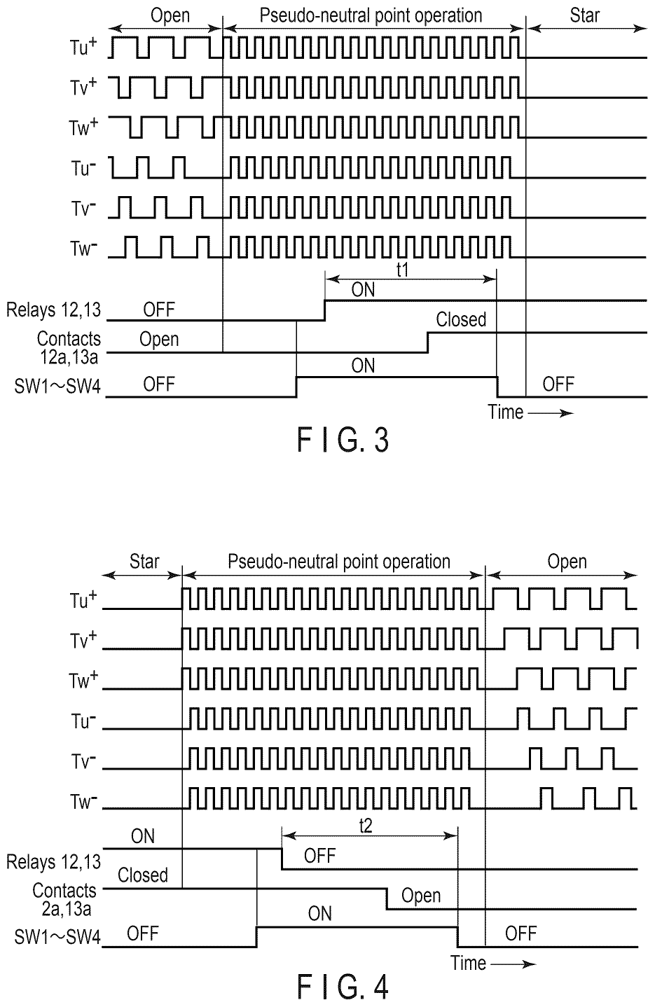

If changing to the star connection mode is necessary (YES in S2), the main control section 40 executes the pseudo-neutral point operation of alternately turning on and off all the upper switch elements Tu, Tv, and Tw and all the lower switch elements Tx, Ty, and Tz in the inverter 30 with an on/off duty of 50% as shown in FIG. 3 such that the potential difference between both ends of each of the relay contacts 12a and 13a becomes zero (S3).

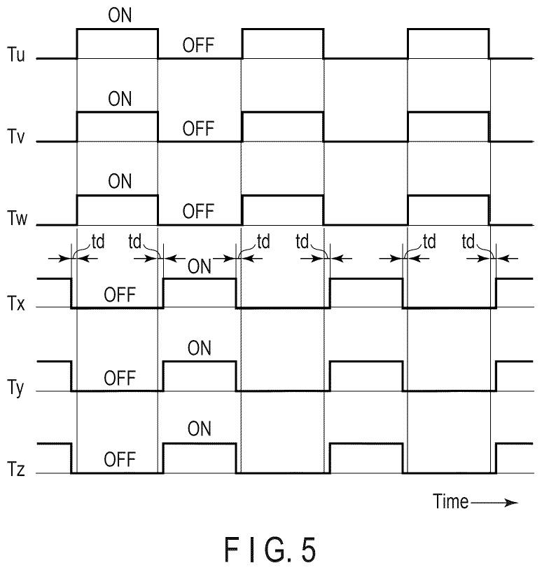

The relationship between the on/off of the upper switching elements Tu, Tv, and Tw and the on/off of the lower switching elements Tx, Ty, and Tz in this pseudo-neutral point operation is enlarged in time in FIG. 5 to make the relationship easily understood. The main control section 40 ensures a dead time td in which both the upper switch elements Tu, Tv, and Tw and the lower switch elements Tx, Ty, and Tz become in an off state, in order to prevent formation of a short circuit to the output terminal of the converter 10 when turning on the upper switch elements Tu, Tv, and Tw and turning off the lower switch elements Tx, Ty, and Tz. Similarly, the main control section 40 ensures a dead time td in which both the lower switch elements Tx, Ty, and Tz and the upper switch elements Tu, Tv, and Tw become in an off state, in order to prevent formation of a short circuit to the output terminal of the converter 10 when turning on the lower switch elements Tx, Ty, and Tz and turning off the upper switch elements Tu, Tv, and Tw.

There are various methods for generating the dead time td, but the general method is to turn off the switch element that needs to be turned off, and then turn on the switch element that needs to be turned on after the dead time td has elapsed. It is desirable to make the dead time td as short as possible from the viewpoint of efficiency and waveforming and, in reality, the minimum time is allocated based on the on/off transient characteristics of the switching element.

As described later, however, even if the pseudo-neutral point operation is executed due to the existence of the dead time td, when the switching timing of the inverter 30 and the activation timing of the relay contacts 12a and 13a overlap with the dead time td, a potential difference may occur between both ends of the relay contacts 12a and 13a.

During the execution of the pseudo-neutral point operation, the main control section 40 first turns on the auxiliary switches SW1 to SW4 (S4), thereby short-circuiting both ends of each of the relay contacts 12a and 13a, and after the short-circuiting, turning on the relays 12 and 13 (S5). Next, after a certain time t1 which is longer than the time required for the relay contacts 12a and 13a to be actually closed, has elapsed (YES in S6), the main control section 40 turns off the auxiliary switches SW1 to SW4 (S7). After this, the main control section 40 ends the pseudo-neutral point operation and shifts to motor drive in the star connection mode (S8).

After shifting, the main control section 40 returns to the above determination in S1. The on/off drive of turning on the auxiliary switches SW1 to SW4 in step S4 and turning off the auxiliary switches SW1 to SW4 in step S7 is desirably executed by synchronizing all the auxiliary switches from the viewpoint of circuit simplification and the like, but the auxiliary switches do not need to be turned on and off in complete synchronization. The point is that all the auxiliary switches SW1 to SW4 can be turned on before the relay contacts 12a and 13a are actually closed and that all the auxiliary switches SW1 to SW4 can be turned off after the relay contacts 12a and 13a are actually closed.

The operation shown in FIG. 3 is executed by the above processing. Since the auxiliary switches SW1 to SW4 are turned off by this operation, during a stable operation in the star connection mode, power consumption at the time when the auxiliary switches SW1 to SW4 are on is eliminated, energy is saved, heat generation of the auxiliary switches SW1 to SW4 does not occur, and measures against the temperature rise of these semiconductor switches are unnecessary.

When the motor is driven in the star connection mode (NO in S1), the main control section 40 monitors whether or not it is necessary to change the mode to the open-winding mode in response to an increase in load (S9). If changing the mode to the open-winding mode is unnecessary (NO in S9), the main control section 40 returns to the above determination in S1.

If changing the mode to the open-winding mode is necessary (YES in S9), the main control section 40 executes the pseudo-neutral point operation of alternately turning on and off the upper switch elements Tu, Tv, and Tw and the lower switch elements Tx, Ty, and Tz in the inverter 30 with an on/off duty of 50% as shown in FIG. 4 such that the potential difference between both ends of each of the relay contacts 12a and 13a becomes zero (S10). This pseudo-neutral point operation is the same as the pseudo-neutral point operation at the time of changing from the open-winding mode to the star connection mode. Incidentally, in this state, the relay contacts 12a and 13a are on since the operation is in the star connection mode.

During the execution of the pseudo-neutral point operation, the main control section 40 first turns on the auxiliary switches SW1 to SW4 (S11), thereby short-circuiting both ends of each of the relay contacts 12a and 13a, and after the short-circuiting, turning off the relays 12 and 13 (S12). Next, after a certain time t2 which is longer than the time required for the relay contacts 12a and 13a to be actually opened, has elapsed (YES in S13), the main control section 40 turns off the auxiliary switches SW1 to SW4 (S14). After this, the main control section 40 ends the pseudo-neutral point operation and shifts to the open-winding mode (S15).

After shifting, the main control section 40 returns to the above determination in S1. The on/off drive of turning on the auxiliary switches SW1 to SW4 in step S11 and turning off the auxiliary switches SW1 to SW4 in step S14 is desirably executed by synchronizing all the auxiliary switches SW1 to SW4, but the auxiliary switches do not need to be turned on and off in complete synchronization. All the auxiliary switches SW1 to SW4 can be turned on before the relay contacts 12a and 13a are actually opened, and all the auxiliary switches SW1 to SW4 can be turned off after the relay contacts 12a and 13a are actually opened. The operation shown in FIG. 4 is executed by the above processing.

The certain times t1 and t2 may be the same time, and may desirably be as short as possible from the viewpoint of efficiency. In the mechanical relays 12 and 13, a delay of 10 to 30 msec occurs between turning on (energizing) and turning off (deenergizing) by the excitation current until the relay contacts 12a and 13a are actually opened and closed. It is desirable to set the certain times t1 and t2 to approximately 50 msec to 100 msec, which is obtained by adding an allowance to the delay time for the relay contacts 12a and 13a to be opened and closed.

As described above, when opening and closing the relay contacts 12a and 13a, the pseudo-neutral point operation is executed in advance and the auxiliary switches SW1 to SW4 are turned on such that the potential difference between both ends of the relay contacts 12a and 13a becomes zero.

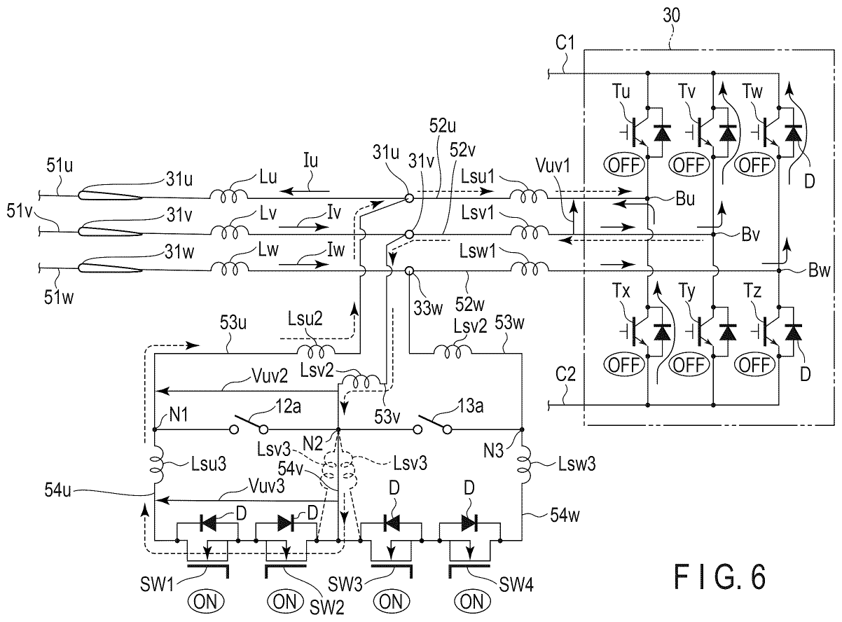

However, even if the pseudo-neutral point operation is executed, a current flows through a path passing through the freewheeling diode D of any one of the upper switch elements Tu, Tv, and Tw and the lower switch elements Tx, Ty, and Tz only during the dead time td when the upper switch elements Tu, Tv, and Tw and the lower switch elements Tx, Ty, and Tz of the inverter 30 are both turned off. For example, as indicated by an arrow of solid line in FIG. 6, motor currents Iv and Iw flow through paths passing from the phase wires Lv and Lw through the interconnection points By and Bw of the inverter 30 and the freewheeling diodes D of the respective upper switch elements Tv and Tw, and the motor current Iu flows through a path from the freewheeling diode D of the lower switch element Tx to the phase winding Lu through the interconnection point Bu.

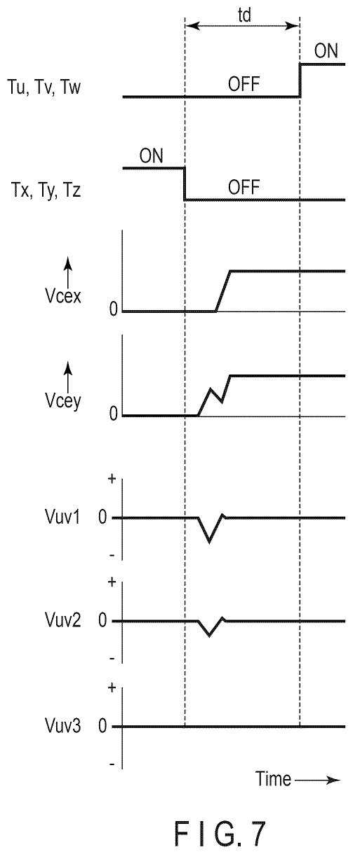

The relationship among a collector-emitter voltage Vcex of the lower switch element Tx, a collector-emitter voltage Vcey of the lower switch element Ty, a potential difference Vuv1 between the interconnection points Bu and Bv, a potential difference Vuv2 between both ends of the relay contact 12a, and a potential difference Vuv3 between both ends of the series circuit of the auxiliary switches Sw1 and Sw2, in the current path of FIG. 6, is shown in FIG. 7. In other words, in a state in which the collector-emitter voltage Vcex of the lower switch element Tx is zero, the collector-emitter voltage Vcey of the lower switch element Ty rises and, accordingly, the potential difference Vuv1 of the interconnection points Bu and By does not become zero. When the potential difference Vuv1 occurs, a current flows from the interconnection point By toward the interconnection point Bu via the auxiliary switch SW2 and the auxiliary switch Sw1, a voltage is generated in the first inductances Lsu1 and Lsv1 and the second inductances Lsu2 and Lsv2, and the potential difference Vuv2 between both ends of the relay contact 12a is no longer zero, as indicated by an arrow of a broken line in FIG. 6. After this, the collector-emitter voltage Vcex of the lower switch element Tx and the collector-emitter voltage Vcey of the lower switch element Ty become the same value and, accordingly, the potential difference Vuv1 between the interconnection points Bu and By becomes zero. The same phenomenon also occurs at the relay contact 13a.

Since the opening/closing timing cannot be controlled strictly as described above in the relay contact 12a, which is a mechanical opening/closing contact, the relay contact 12a may be opened or closed at the timing when the potential difference Vuv2 between both ends of the relay contact 12a is not zero. If the relay contact 12a is opened or closed in a state in which the potential difference Vuv2 between both ends of the relay contact 12a is not zero, a surge voltage or an arc may occur between both ends of the relay contact 12a. Since the dead time td is extremely short compared to the regular on/off period of the inverter 30, it is extremely unlikely that the relay contact 12a may be opened or closed in a state in which the potential difference between both ends of the relay contact 12a is not actually zero. However, since the probability of its occurrence is not 0, some kind of countermeasure is required.

In this example, the potential difference Vuv2 between both ends of the relay contact 12a changes depending on the relationship among the total value “Lsv1+Lsv2” of the value of the first inductance Lsu1 of the wire 52u from the interconnection point Bu to the branch point N1 and the value of the second inductance Lsu2 of the wire 53u, the total value=“Lsv1+Lsv2” of the value of the first inductance Lsv1 of the wire 52v from the interconnection point By to the branch point N2 and the value of the second inductance Lsv2 of the wire 53v, the value of the third inductance Lsu3 of the wire 54u between the branch point N1 and one end of the series circuit of the auxiliary switches SW1 and SW2, and the third inductance Lsu3 of the wire 54v between the branch point N2 and the other end of the series circuit of the auxiliary switches SW1 and SW2.

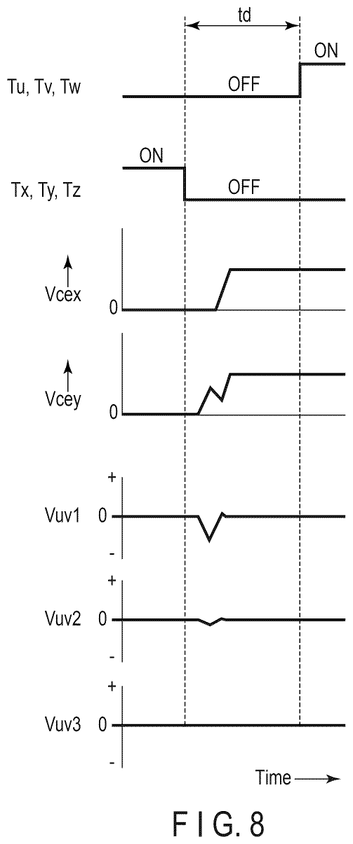

For example, if the total value “Lsu1+Lsu2” of the value of the first inductance Lsu1 and the value of the second inductance Lsu2 is smaller than the value of the third inductance Lsu3 (“Lsu1+Lsu2”<Lsu3) and if the total value “Lsv1+Lsv2” of the value of the first inductance Lsv1 and the value of the second inductance Lsv2 is smaller than the value of the third inductance Lsv3 (“Lsv1+Lsv2”<Lsv3), the potential difference Vuv2 of the magnitude shown in FIG. 7 occurs. In contrast, if the value of the third inductance Lsu3 is smaller than the above-mentioned “total value “Lsu1+Lsu2” (Lsu3<“Lsu1+Lsu2”) and if the value of the third inductance Lsv3 is smaller than the above-mentioned total value “Lsv1+Lsv2” (Lsv3<“Lsv1+Lsv2”), the potential difference Vuv2 can be suppressed to be smaller than that in the case of FIG. 7 as shown in FIG. 8.

Similarly, the potential difference Vuw2 between both ends of the relay contact 13a changes depending on the relationship among the total value “Lsv1+Lsv2” of the value of the first inductance Lsu1 of the wire 52v from the interconnection point By to the branch point N2 and the value of the second inductance Lsv2 of the wire 53v, the total value “=Lsw1+Lsw2” of the value of the first inductance Lsw1 of the wire 52w from the interconnection point Bw to the branch point N3 and the value of the second inductance Lsw2 of the wire 53w, the value of the third inductance Lsv3 of the wire 54v between the branch point N2 and one end of the series circuit of the auxiliary switches SW3 and SW4, and the third inductance Lsw3 of the wire 54w between the branch point N3 and the other end of the series circuit of the auxiliary switches SW3 and SW4.

In other words, if the value of the third inductance Lsv3 is smaller than the above-mentioned “total value “Lsv1+Lsv2” (Lsv3<“Lsv1+Lsv2”) and if the value of the third inductance Lsw3 is smaller than the above-mentioned total value “Lsw1+Lsw2” (Lsw3<“Lsw1+Lsw2”), the potential difference Vvw2 between both ends of the relay contact 13a can be suppressed to a small value. By setting the inductance value in this manner, the adverse effect on the relay contacts 12a and 13a can be reduced to a level that does not cause any problem.

Focusing on these points, in this embodiment, the length of each of the wires (third wires) 54u, 54v, and 54w is set to be as short as possible or shorter than the total value of the length of each of the wires (first wires) 52u, 52v, and 52w and the length of each of the wires (second wires) 53u, 53v, and 53w, such that the value of the third inductance Lsu2 is smaller than the total value “Lsu1+Lsu2” of the value of the first inductance Lsu1 and the value of the second inductance Lsu2 (Lsu1<“Lsu1+Lsu2”), that the value of the third inductance Lsv2 is smaller than the total value “Lsv1+Lsv2” of the value of the first inductance Lsv1 and the value of the second inductance Lsv2 (Lsv1<“Lsv1+Lsv2”), that the value of the third inductance Lsw2 is smaller than the total value “Lsv1+Lsv2” of the value of the first inductance Lsw1 and the value of the second inductance Lsw2 (Lsv1<“Lsw1+Lsw2”), and that the potential differences Vuv2 and Vvw2 become small. For example, by making the positions of arrangement of the relay contacts 12a and 13a and the positions of arrangement of the auxiliary switches SW1 to SW4 as close as possible, the lengths of the wires 54u, 54v, and 54w can be shortened.

The value of parasitic inductance occurring in wires such as the first inductances Lsu1, Lsv1, and Lsw1, the second inductances Lsu2, Lsv2, and Lsw2, and the third inductance Lsu3, Lsv3, and Lsw3 is substantially proportional to the length of the wire. The shorter the lengths of the wires 54u, 54v, and 54w are, the smaller the values of the third inductances Lsu3, Lsv3, and Lsw3 can be. Therefore, in the present embodiment, it is set that “length of wire 54u+length of wire 52u”>“length of wire 53u”, that “length of wire 54v+length of wire 52v”>“length of wire 53v”, and that “length of wire 54w+length of wire 52w”>“length of wire 53w”.

Incidentally, since the magnitudes of the potential differences Vuv2 and Vvw2 between both ends of the respective relay contacts 12a and 13a are determined by the relative relationship between the above total values “Lsu1+Lsu2”, “Lsv1+Lsv2”, and “Lsw1+Lsw2” and the values of the third inductances Lsu3, Lsv3, and Lsw3, the potential differences Vuv2 and Vvw2 can be suppressed to small values even if the total values “Lsu1+Lsu2”, “Lsv1+Lsv2”, and “Lsw1+Lsw2” are made larger than the values of the third inductances Lsu3, Lsv3, and Lsw3. In order to make the total values “Lsu1+Lsu2”, “Lsv1+Lsv2”, and “Lsw1+Lsw2” larger than the values of the third inductance Lsu3, Lsv3, and Lsw3, the total values of the lengths of the wires 52u, 52v, and 52w and the lengths of the wires 53u, 53v, and 53w need only to be made longer. In addition, in order to make the total values “Lsu1+Lsu2”, “Lsv1+Lsv2”, and “Lsw1+Lsw2” larger than the values of the third inductances Lsu3, Lsv3, and Lsw3, an inductance element such as a small coil may be inserted into a middle part of each of the wires 52u, 52v, and 52w or the wires 53u, 53v, and 53w. According to these countermeasures, however, since the resistance value increases accordingly and causes power loss in accordance with extension of the wire length or addition of coils, the treatment of making the lengths of the wires 54u, 54v, and 54w as short as possible is desirable as described above.

Thus, by suppressing the potential differences Vuv2 and Vvw2 that occur between both ends of the respective relay contacts 12a and 13a, it is possible to eliminate the problem of large surge voltages and arcs that may cause problems between both ends of the respective relay contacts 12a and 13a even if the relay contacts 12a and 13a are opened and closed with the potential differences Vuv2 and Vvw2. As a result, it is possible to avoid an adverse effect on the life of the relays 12 and 13, and to prevent destruction of each switch element of the inverters 20 and 30 due to surge voltage and arc.

### (2) Second Embodiment

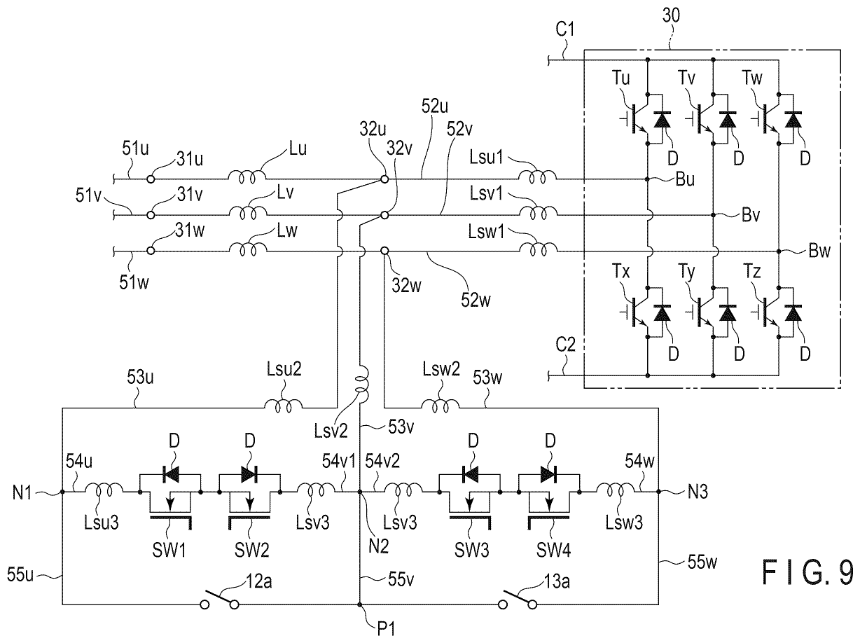

FIG. 9 shows a configuration of the second embodiment.

A series circuit of auxiliary switches SW1 and SW2 is connected via wires (third wires) 54u and 54v1, between branch points N1 and N2 at tips of wires (second wires) 53u and 53v connected to other ends (terminals 32u and 32v) of phase wires Lu and Lv of a motor 1M. A series circuit of auxiliary switches SW3 and SW4 is connected via wires (third wires) 54v2 and 54w, between branch points N2 and N3 at tips of wires (second wires) 53v and 53w connected to other ends (terminals 32v and 32w) of phase wires Lv and Lw of the motor 1M.

Then, a relay contact 12a is connected between the branch points N1 and N2 via wires (fourth wires) 55u and 55v. A relay contact 13a is connected between branch points N2 and N3 via wires (fourth wires) 55v and 55w.

In other words, the tip of the wire 53u branches into the wire 54u and the wire 55u at the branch point N1, and the tip of the wire 53v branches into three wires, i.e., the wires 54v1 and 54v2 and the wire 55v at the branching point N2. Similarly, the tip of the wire 53w branches into the wire 54w and the wire 55w at the branch point N3. The wire 54u is connected to an auxiliary switch SW1 side in the series circuit of auxiliary switches SW1 and SW2, and the wire 54v1 is connected to the auxiliary switch SW2 side in the series circuit of the auxiliary switches SW1 and SW2. The wire 54v2 is connected to an auxiliary switch SW3 side in the series circuit of auxiliary switches SW3 and SW4, and the wire 54w is connected to the auxiliary switch SW4 side in the series circuit of the auxiliary switches SW3 and SW4. The auxiliary switches SW2 and SW3 are connected in series to each other via the branch point N2 and the wires 54v1 and 54v2.

The wires 54u and 54v1 start at the branch points N1 and N2 and end at both ends of the series circuit of the auxiliary switches SW1 and SW2. The wires 54v2 and 54w start at the branch points N2 and N3 and end at both ends of the series circuit of the auxiliary switches SW2 and SW3.

The relay contact 12a is connected in parallel to the series circuit of the auxiliary switches SW1 and SW2 via the wires 55u and 55v. The relay contact 13a is connected in parallel to the series circuit of auxiliary the switches SW3 and SW4 via the wires 55v and 55w. The wire 55u is electrically connected to the wire 53u via the branch point N1, the wire 55v is electrically connected to the wire 53v via the branch point N2, and the wire 55w is electrically connected to the wire 53w via the branch point N2. The other end of the relay contact 12a and one end of the relay contact 13a are electrically connected via a common connection point P1 connected to the wire 55v. The wires 55u and 55v start at the branch points N1 and N2 and end at both ends of the relay contact 12a. The wires 55v and 55w start at the branch points N2 and N3 and end at both ends of the relay contact 12a.

In the second embodiment as well, similarly to the first embodiment, the relationship among the values of the first inductances Lsu1, Lsv1, and Lsw1, the values of the second inductances Lsu2, Lsv2, and Lsw2, and the values of the third inductances Lsu3, Lsv3, and Lsw3 need to satisfy the above-described conditions (Lsu1<“Lsu1+Lsu2”), (Lsv1<“Lsv1+Lsv2”), and (Lsw1<“Lsw1+Lsw2”). Therefore, by using the circuit configuration of the second embodiment, the above conditions can be satisfied without performing a troublesome wiring design since the length of the wires 54u to 54w can be extremely shortened in terms of the circuit configuration.

The other constituent elements are the same as those of the first embodiment.

### (3) Third Embodiment

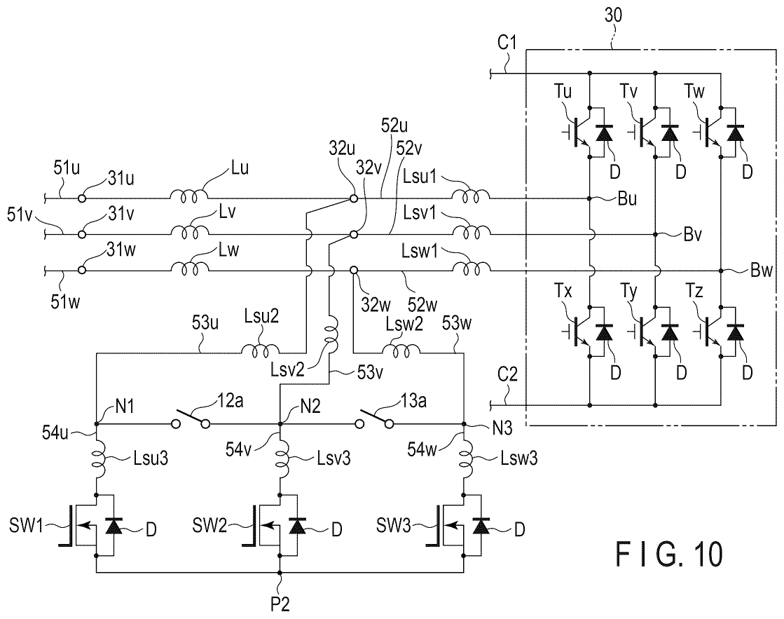

FIG. 10 shows main portions of a configuration of the third embodiment.

A relay contact 12a is connected between branch points N1 and N2 at the tips of wires 53u and 53v connected to the other ends (terminals 32u and 32v) of phase wires Lu and Lv of a motor 1M. A relay contact 13a is connected between branch points N2 and N3 at the tips of wires 53v and 53w connected to the other ends (terminals 32v and 32w) of phase wires Lv and Lw of the motor 1M.

Then, a series circuit of auxiliary switches SW1 and SW2 is connected in parallel to the relay contact 12a by the wires 54u and 54v connected to the branch points N1 and N2. A series circuit of auxiliary switches SW2 and SW3 is connected in parallel to a relay contact 13a by the wires 54v and 54w connected to the branch points N2 and N3. The auxiliary switches SW1 to SW3 are semiconductor switch elements, for example IGBT and MOS-FET, in which a freewheeling diode D is connected in antiparallel direction to its element body. An emitter of each of the three auxiliary switches SW1, SW2, and SW3 is commonly connected at a common connection point (virtual neutral point) P2 in the drawing.

The first wire 54u and the second wire 54v start at the branch points N1 and N2 and end at both ends of the series circuit of the auxiliary switches SW1 and SW2. The second wire 54v and the third wire 54w start at the branch points N2 and N3 and end at both ends of the series circuit of the auxiliary switches SW2 and SW3.

The other constituent elements are the same as those of the first embodiment, including the relationship among the values of the first inductances Lsu1, Lsv1, and Lsw1, the values of the second inductances Lsu2, Lsv2, and Lsw2, and the values of the third inductances Lsu3, Lsv3, and Lsw3. The three auxiliary switches SW1, SW2, and SW3 are simultaneously controlled on and off in the same manner as the four auxiliary switches SW1 to SW4 of the first embodiment.

By turning off the auxiliary switches SW1, SW2, and SW3 in a state in which the relay contacts 12a and 13a are open, the phase wires Lu, Lv, and Lw of the motor 1M become an open-winding state of being separated from each other. By turning on the auxiliary switches SW1, SW2, and SW3 in a state in which the relay contacts 12a and 13a are open, the other ends of the phase wires Lu, Lv, and Lw of the motor 1M are short-circuited via the auxiliary switches SW1, SW2, and SW3 and the common connection point P2 and become a star connection mode. By closing the relay contacts 12a and 13a in a state in which the auxiliary switches SW1, SW2, and SW3 are turned off, the other ends of the phase windings Lu, Lv, and Lw of the motor 1M are short-circuited via the relay contacts 12a and 13a and the branch point N2 and become a star connection mode.

According to the configuration of the present embodiment, the number of auxiliary switches SW1, SW2, and SW3, i.e., the number of semiconductor switch elements, is reduced to three, the number of semiconductor switch elements is smaller than that in the first and second embodiments, and the circuit can be simplified.

### (4) Fourth Embodiment

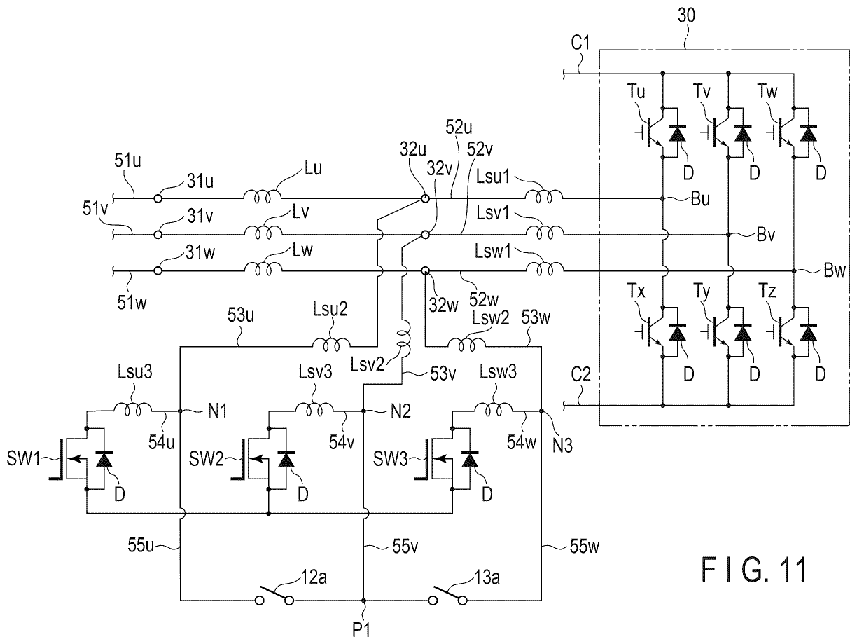

FIG. 11 shows main portions of a configuration of the fourth embodiment.

A series circuit of auxiliary switches SW1 and SW2 is connected, by wires (third wires) 54u and 54v, between branch points N1 and N2 at tips of wires (second wires) 53u and 53v connected to other ends (terminals 32u and 32v) of phase wires Lu and Lv of a motor 1M. A series circuit of auxiliary switches SW3 and SW4 is connected, by wires (third wires) 54v and 54w, between branch points N2 and N3 at tips of wires (second wires) 53v and 53w connected to other ends (terminals 32v and 32w) of phase wires Lv and Lw of the motor 1M.

Then, a relay contact 12a is connected in parallel to the series circuit of the auxiliary switches SW1 and SW2 by wires (fourth wires) 55u and 55v connected to the branch points N1 and N2. A relay contact 13a is connected in parallel to the series circuit of the auxiliary switches SW2 and SW3 by wires (fourth wires) 55v and 55w connected to the branch points N2 and N3. The other end of the relay 12a connected to the wire 55v and one end of the relay 13a connected to the wire 55v are connected at a common connection point P1.

The first wire 54u and the second wire 54v start at the branch points N1 and N2 and end at both ends of the series circuit of the auxiliary switches SW1 and SW2. The second wire 54v and the third wire 54w start at the branch points N2 and N3 and end at both ends of the series circuit of the auxiliary switches SW2 and SW3.

The first wire 55u and the second wire 55v start at the branch points N1 and N2 and end at both ends of the relay contact 12a. The second wire 55v and the third wire 55w start at the branch points N2 and N3 and end at both ends of the relay contact 13a.

The other constituent elements are the same as those of the first embodiment, including the relationship among the values of the first inductances Lsu1, Lsv1, and Lsw1, the values of the second inductances Lsu2, Lsv2, and Lsw2, and the values of the third inductances Lsu3, Lsv3, and Lsw3. The three auxiliary switches SW1, SW2, and SW3 are simultaneously controlled on and off in the same manner as the four auxiliary switches SW1 to SW4 of the first embodiment.

By turning off the auxiliary switches SW1, SW2, and SW3 in a state in which the relay contacts 12a and 13a are open, the phase wires Lu, Lv, and Lw of the motor 1M become an open-winding state of being separated from each other. By turning on the auxiliary switches SW1, SW2, and SW3 in a state in which the relay contacts 12a and 13a are open, the other ends of the phase wires Lu, Lv, and Lw of the motor 1M are short-circuited via the auxiliary switches SW1, SW2, and SW3 and the common connection point P2 and become a star connection mode. By closing the relay contacts 12a and 13a in a state in which the auxiliary switches SW1, SW2, and SW3 are turned off, the other ends of the phase windings Lu, Lv, and Lw of the motor 1M are short-circuited via the relay contacts 12a and 13a and the branch point N2 and become a star connection mode.

According to the configuration of the present embodiment, the number of auxiliary switches SW1, SW2, and SW3, i.e., the number of semiconductor switch elements, is reduced to three, the number of semiconductor switch elements is smaller than that in the first and second embodiments, and the circuit can be simplified.

### (5) Modification Examples

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A motor drive apparatus of a motor including a plurality of phase wires disconnected to each other, the motor drive apparatus comprising:
a first inverter including a plurality of series circuits of upper switch elements and lower switch elements, both ends of the series circuits being connected to a DC power supply, an interconnection point of the upper switch element and the lower switch element of each of the series circuits being connected to one end of each of the phase wires;
a second inverter including a plurality of series circuits of upper switch elements and lower switch elements, both ends of the series circuits being connected to the DC power supply, an interconnection point of the upper switch element and the lower switch element of each of the series circuits being connected to the other end of each of the phase wires by each of first wires;
a plurality of switching contacts connected between the other ends of each of the phase wires by each of second wires;
a plurality of semiconductor switch elements connected in parallel to each of the switching contacts by each of third wires; and
a controller controlling drive of the first inverter, drive of the second inverter, and opening and closing of each of the switching contacts, wherein
when opening and closing each of the switching contacts, the controller executes a pseudo-neutral point operation of alternately turning on and off all the upper switch elements and all the lower switch elements in the second inverter and turns on each of the semiconductor switch elements, in advance,
each of the first wires has a first inductance,
each of the second wires has a second inductance,
each of the third wires has a third inductance, and
a value of the third inductance is smaller than a total value of the value of the first inductance and the value of the second inductance.

2. The motor drive apparatus of claim 1, wherein
the controller selectively sets a star connection mode of interconnecting other ends of the phase wires and executing on/off drive of each of the switch elements of the first inverter, by closing each of the switching contacts, and an open-winding mode of setting the other end of each of the phase wires in a disconnected state and executing on/off drive of each of the switch elements of the first inverter and each of the switch elements of the second inverter in association with each other, by opening each of the switching contacts.

3. The motor drive apparatus of claim 1, wherein
the controller ensures a dead time to turn off both the upper switch element and the lower switch element of each of the series circuits in the first inverter during on/off drive of the upper switch element and the lower switch element in the first inverter, and to turn off both the upper switch element and the lower switch element of each of the series circuits in the second inverter during on/off drive of the upper switch element and the lower switch element in the second inverter.

4. A motor drive apparatus of a motor including a plurality of phase wires disconnected to each other, the motor drive apparatus comprising:
a first inverter including a plurality of series circuits of upper switch elements and lower switch elements, both ends of the series circuits being connected to a DC power supply, an interconnection point of the upper switch element and the lower switch element of each of the series circuits being connected to one end of each of the phase wires;
a second inverter including a plurality of series circuits of upper switch elements and lower switch elements, both ends of the series circuits being connected to the DC power supply, an interconnection point of the upper switch element and the lower switch element of each of the series circuits being connected to the other end of each of the phase wires by each of first wires;
a plurality of semiconductor switch elements connected between other ends of the respective phase wires by each of second wires and each of third wires;
a plurality of switching contacts connected in parallel to each of the semiconductor switch elements by each of fourth wires; and
a controller controlling drive of the first inverter, drive of the second inverter, and opening and closing of each of the switching contacts, wherein
when opening and closing each of the switching contacts, the controller executes a pseudo-neutral point operation of alternately turning on and off all the upper switch elements and all the lower switch elements in the second inverter and turns on each of the semiconductor switch elements, in advance,
each of the first wires has a first inductance,
each of the second wires has a second inductance,
each of the third wires has a third inductance, and
a value of the third inductance is smaller than a total value of the value of the first inductance and the value of the second inductance.

5. The motor drive apparatus of claim 4, wherein
the controller selectively sets a star connection mode of interconnecting other ends of the phase wires and executing on/off drive of each of the switch elements of the first inverter, by closing each of the switching contacts, and an open-winding mode of setting the other end of each of the phase wires in a disconnected state and executing on/off drive of each of the switch elements of the first inverter and each of the switch elements of the second inverter in association with each other, by opening each of the switching contacts.

6. The motor drive apparatus of claim 4, wherein
the controller ensures a dead time to turn off both the upper switch element and the lower switch element of each of the series circuits in the first inverter during on/off drive of the upper switch element and the lower switch element in the first inverter, and to turn off both the upper switch element and the lower switch element of each of the series circuits in the second inverter during on/off drive of the upper switch element and the lower switch element in the second inverter.

7. A motor drive apparatus of a motor including a plurality of phase wires disconnected to each other, the motor drive apparatus comprising:
a first inverter including a plurality of series circuits of upper switch elements and lower switch elements, both ends of the series circuits being connected to a DC power supply, an interconnection point of the upper switch element and the lower switch element of each of the series circuits being connected to one end of each of the phase wires;
a second inverter including a plurality of series circuits of upper switch elements and lower switch elements, both ends of the series circuits being connected to the DC power supply, an interconnection point of the upper switch element and the lower switch element of each of the series circuits being connected to the other end of each of the phase wires by each of first wires;
a plurality of switching contacts connected between the other ends of each of the phase wires by each of second wires;
a plurality of semiconductor switch elements connected in parallel to each of the switching contacts by each of third wires; and
a controller controlling drive of the first inverter, drive of the second inverter, and opening and closing of each of the switching contacts, wherein
when opening and closing each of the switching contacts, the controller executes a pseudo-neutral point operation of alternately turning on and off all the upper switch elements and all the lower switch elements in the second inverter and turns on each of the semiconductor switch elements, in advance,
each of the first wires has a length,
each of the second wires has a length,
each of the third wires has a length, and
in all the third wires, a length of the third wire is shorter than a total value of a length of the first wire connected to the third wire and a length of the second wire.

8. The motor drive apparatus of claim 1, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the switching contacts are a first switching contact connected between the branch points N1 and N2, and a second switching contact connected between the branch points N2 and N3,
the semiconductor switch elements are three semiconductor switch elements Sw1, Sw2, and Sw3, and
the third wires are three third wires in which a first third wire and a second third wire start at the branch points N1 and N2 and end at both ends of a series circuit of the semiconductor switch elements Sw1 and Sw2, and in which the second third wire and a third third wire start at the branch points N2 and N3 and end at both ends of a series circuit of the semiconductor switch elements Sw2 and Sw3.

9. The motor drive apparatus of claim 7, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the switching contacts are a first switching contact connected between the branch points N1 and N2, and a second switching contact connected between the branch points N2 and N3,
the semiconductor switch elements are three semiconductor switch elements Sw1, Sw2, and Sw3, and
the third wires are three third wires in which a first third wire and a second third wire start at the branch points N1 and N2 and end at both ends of a series circuit of the semiconductor switch elements Sw1 and Sw2, and in which the second third wire and a third third wire start at the branch points N2 and N3 and end at both ends of a series circuit of the semiconductor switch elements Sw2 and Sw3.

10. The motor drive apparatus of claim 1, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the switching contacts are a first switching contact connected between the branch points N1 and N2, and a second switching contact connected between the branch points N2 and N3,
the semiconductor switch elements are three semiconductor switch elements Sw1, Sw2, and Sw3,
the three semiconductor switch elements Sw1, Sw2, and Sw3 have one-side ends connected commonly, and
in the third wires, a first third wire starts at the branch point N1 and ends at the other end of the semiconductor switch element Sw1, the second third wire starts at the branch point N2 and ends at the other end of the semiconductor switch element Sw2, and the third third wire starts at the branch point N3 and ends at the other end of the semiconductor switch element Sw3.

11. The motor drive apparatus of claim 7, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the switching contacts are a first switching contact connected between the branch points N1 and N2, and a second switching contact connected between the branch points N2 and N3,
the semiconductor switch elements are three semiconductor switch elements Sw1, Sw2, and Sw3,
the three semiconductor switch elements Sw1, Sw2, and Sw3 have one-side ends connected commonly, and
in the third wires, a first third wire starts at the branch point N1 and ends at the other end of the semiconductor switch element Sw1, the second third wire starts at the branch point N2 and ends at the other end of the semiconductor switch element Sw2, and the third third wire starts at the branch point N3 and ends at the other end of the semiconductor switch element Sw3.

12. The motor drive apparatus of claim 4, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the semiconductor switch elements are three semiconductor switch elements Sw1, Sw2, and Sw3,
the third wires are three third wires in which a first third wire and a second third wire start at the branch points N1 and N2 and end at both ends of a series circuit of the semiconductor switch elements Sw1 and Sw2, and in which the second third wire and a third third wire start at the branch points N2 and N3 and end at both ends of a series circuit of the semiconductor switch elements Sw2 and Sw3, and
the fourth wires are three fourth wires in which a first fourth wire and a second fourth wire start at the branch points N1 and N2 and end at both ends of the first switching contact, and in which the second fourth wire and a third fourth wire end at both ends of the second switching contact.

13. The motor drive apparatus of claim 7, wherein
the phase wires are three phase wires Lu, Lv, and Lw,
the first wires are three first wires connected to other ends of the Lu, Lv, and Lw,
the second wires are three second wires starting at other ends of the Lu, Lv, and Lw, and ending at three branch points N1, N2, and N3,
the semiconductor switch elements are three semiconductor switch elements Sw1, Sw2, and Sw3,
the third wires are three third wires in which a first third wire and a second third wire start at the branch points N1 and N2 and end at both ends of a series circuit of the semiconductor switch elements Sw1 and Sw2, and in which the second third wire and a third third wire start at the branch points N2 and N3 and end at both ends of a series circuit of the semiconductor switch elements Sw2 and Sw3, and
the fourth wires are three fourth wires in which a first fourth wire and a second fourth wire start at the branch points N1 and N2 and end at both ends of the first switching contact, and in which the second fourth wire and a third fourth wire end at both ends of the second switching contact.

14. The motor drive apparatus of claim 1, wherein
each of the semiconductor switch elements has a freewheeling diode connected to its main body in an antiparallel direction.

15. The motor drive apparatus of claim 4, wherein
each of the semiconductor switch elements has a freewheeling diode connected to its main body in an antiparallel direction.

16. The motor drive apparatus of claim 7, wherein
each of the semiconductor switch elements has a freewheeling diode connected to its main body in an antiparallel direction.

17. A refrigeration cycle apparatus comprising a compressor driven by the motor drive apparatus of claim 1.

18. A refrigeration cycle apparatus comprising a compressor driven by the motor drive apparatus of claim 4.

19. A refrigeration cycle apparatus comprising a compressor driven by the motor drive apparatus of claim 7.
